(19) United States
(12) Patent Application Publication
(10) Pub. No.: US 2026/0211726 A1
(43) Pub. Date: Jul. 23, 2026

(54) DYNAMIC ACTIVATION AND DEACTIVATION OF DATA PROCESSING UNIT PORTS BY DATA REDUCTION RATIO (DRR) FORECASTING

(71) Applicant: Dell Products L.P., Round Rock, TX (US)

(72) Inventors: Ramesh Doddaiah, Westborough, MA (US); Jonathan Ichael Krasner, Coventry, RI (US); Xiangping Chen, Sherborn, MA (US)

(21) Appl. No.: 19/034,270

(22) Filed: Jan. 22, 2025

(51) Int. Cl. G06F 9/48; G06F 3/06; G06F 11/30; G06F 11/34

(52) U.S. Cl. CPC G06F 9/4893; G06F 3/0604; G06F 3/0608; G06F 3/064; G06F 3/0671; G06F 11/3041; G06F 11/3452

(57) ABSTRACT

A method for managing data processing units (DPU) ports in a DPU includes receiving, at a multi-variant time series (MVTS) system, first data on input/output (I/O) statistics on a host adapter. The method further includes receiving, at the MVTS system, second data from the DPU. The second data includes a status and power consumption of each DPU port of the DPU. Moreover, the method includes after receiving the first data and the second data, forming, with the MVTS system, an activation schedule for each DPU port in the DPU with the first data and the second data as inputs. The activation schedule specifies whether any given DPU port is activated or deactivated over a series of time periods. Further, the method includes deactivating, at a first time period, the DPU ports indicated to be deactivated by the activation schedule.

### BACKGROUND

In storage arrays, data processing units may be used to perform processing on incoming data such as compression. Not all data received at the storage array is processed by DPUs. To receive, process, and send data, the DPUs include DPU ports to facilitate this activity. When a DPU port is on, the DPU port is continuously operating regardless of if the operation is using the DPU port. DPUs consume significant power due to this continuous operation of the ports.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a computing system in accordance with one or more embodiments disclosed herein.

FIG. 2.1 shows a flowchart for a method for creating an activation schedule in accordance one or more embodiments disclosed herein.

FIG. 2.2 shows an activation schedule in accordance one or more embodiments disclosed herein.

FIG. 2.3 shows a flowchart for a method for creating input/output statistics in accordance one or more embodiments disclosed herein.

FIG. 2.4 shows a flowchart for a method for compressing data in accordance one or more embodiments disclosed herein.

### DETAILED DESCRIPTION

Traditionally, computing devices such as storage arrays use data processing units (DPUs) for tasks such as data compression. These computing devices with the DPUs consume significant power due to continuous operation. A DPU is made up of multiple DPU ports, and under utilized ports consume significant amounts of power that is wasted. The power is wasted because even when only partially being used, an active DPU port is consuming a baseline amount of energy. This baseline amount of energy may be far greater than the amount of energy needed to perform the task before the DPU. For example, if a DPU has four DPU ports and each DPU port has a baseline energy consumption of 10 Watts, the DPU will be consuming 40 Watts of power. If a data compression operation can be done using 20 Watts of power in the DPU, 20 Watts of power will be spent unnecessarily by the DPU.

For at least the reasons discussed above, a different approach/framework may be beneficial for powering DPU ports in a DPU.

Embodiments disclosed herein relate to using a multivariate time series model (MTSM) to detect idle scenarios of DPU ports in a DPU based on real-time workload statistics (input/output statistics) to dynamically switch DPU ports on and off during different workload time periods. The MTSM may forecast whether DPU ports in one or more DPUs should be on or off. By forecasting a bandwidth utilization (e.g., whether a DPU port will be idle or active over a defined time period), 1 to N number of DPU ports in a system may be powered down during a workload event (where N is the number of DPU ports in a system). Powering a DPU port down saves a considerable amount of power as a powered down DPU port does not consume the baseline amount of energy. For example, if a DPU has four DPU ports that have a baseline energy consumption of 10 Watts and two DPU ports are turned off the DPU will be consuming 20 Watts of power. If the DPU performs a data compression task that causes the two active DPU ports to consume 12 Watts of power each, the DPU will be consuming 24 Watts of power compared to the 40 Watts of power the DPU would be consuming if all four DPU ports were active. The DPU(s) in this disclosure may be used in a variety of systems including storage devices such as remote storage arrays. Storage devices in particular would benefit from these embodiments due to the type of workloads performed by storage systems. The DPU(s) in this disclosure may be used for workloads including compression workloads. The workloads for storage systems will particularly benefit from the disclosure due to many of these workloads not utilizing DPU(s) (e.g., red-hot data writes bypass data compression leading to idle DPU ports during this type of workload) resulting in significant idle time for the DPU ports which may be switched off to save energy.

Benefits of the disclosure include promoting sustainability and cost saving in storage systems due to the energy savings by turning off idle DPU ports. The disclosure reduces device heating and prolongs device lifespan by turning off idle DPU ports. Users of the system can increase sustainability metrics by dynamically adjusting DPU port utilization based on workload demands. The disclosure may be expanded to toggle entire DPU(s) on and off within distributed storage arrays across multiple engines leading to increased energy savings.

The following describes various embodiments disclosed herein.

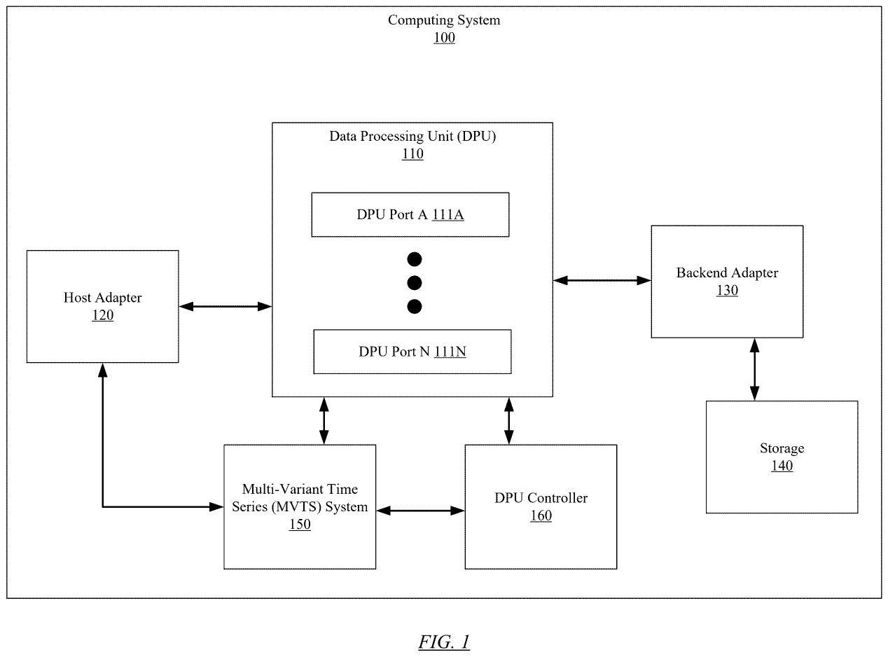

FIG. 1 shows a diagram of a computing system (100) in accordance with one or more embodiments disclosed herein. The computing system (100) includes a DPU (110), a host adapter (120), a backend adapter (130), a storage (140), a multi-variant time series (MVTS) system (150), and a DPU controller (160). Each of these components shown in FIG. 1 is described below.

The system may include additional, fewer, and/or different components without departing from the scope of the embodiments disclosed herein. Each component may be operably/operatively connected to any of the other components via any combination of wired and/or wireless connections (including connections to local area networks, wireless networks, and wide area networks). For example, the components shown in FIG. 1 may be connected via a network fabric (not shown). A network fabric refers to the interconnected topology and structure of network elements, e.g., switches, routers, and links, which work together to provide data transmission within between the components. The network fabric may be implemented using a spine-leaf topology, where every leaf switch connects to each spine switch. Further the wired and wireless connections described may be used to connect the computing system (100) to other computing systems.

The system may include one or more additional computer processor(s) not shown, non-persistent storage (not shown) (e.g., volatile memory, such as RAM, cache memory), a communication interface (not shown) (e.g., Bluetooth interface, infrared interface, network interface, optical interface, etc.), input devices (not shown) (e.g., touchscreen, keyboard, mouse, microphone, touchpad, electronic pen, or any other type of input device), output devices (not shown) (e.g., a display device, a printer, external storage, or any other output device), and numerous other elements (not shown) and functionalities. The communication interface may include an integrated circuit for connecting the computing device to a network (not shown) (e.g., a local area network (LAN), a wide area network (WAN) such as the Internet, mobile network, or any other type of network) and/or to another device, such as another computing device.

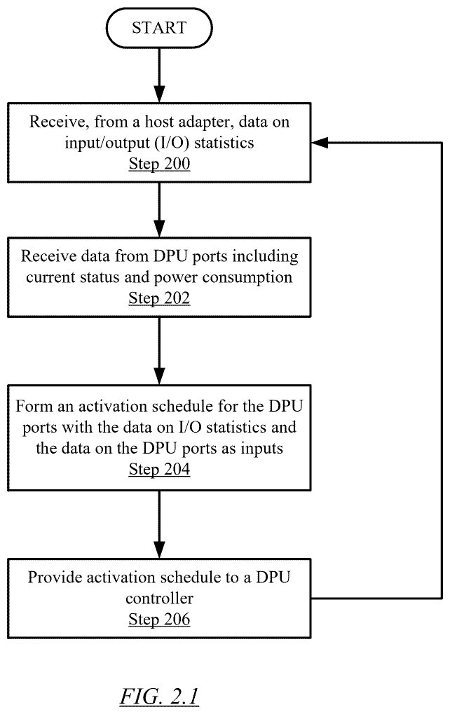

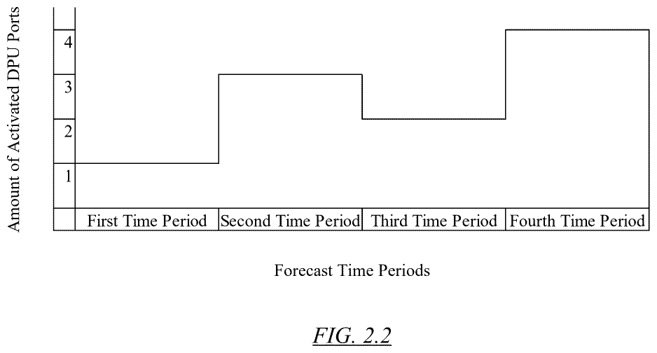

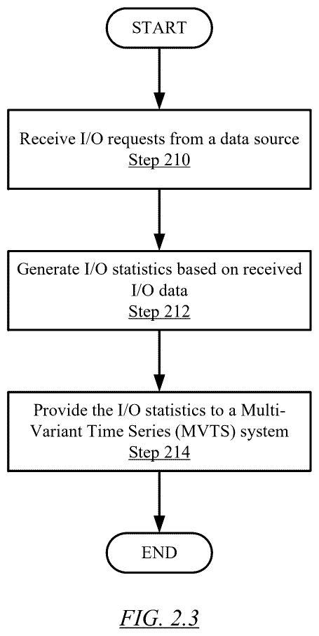

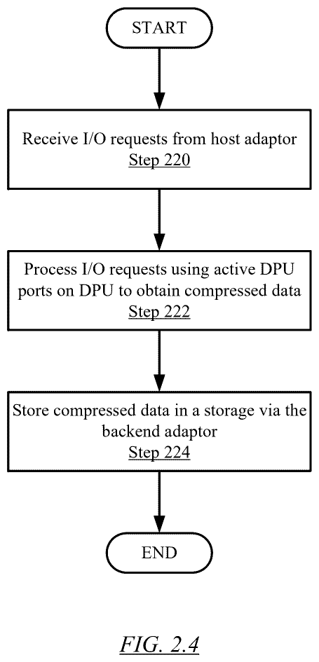

In one or more embodiments, the computing system (100) may be, for example, a server, a distributed computing system, or a cloud resource. The computing system (100) may include one or more processors, memory (e.g., random access memory), and persistent storage (e.g., disk drives, solid state drives, etc.). The computing device may provide the functionality of the computing system (100) described throughout this application and/or all, or a portion thereof, of the methods illustrated in FIGS. 2.1, 2.3, and 2.4.

In one or more embodiments, the DPU (110) is a specialized electronic component that includes one or more network interfaces and is designed to offload various networking tasks (e.g., packet processing, encryption, data compression, and network virtualization) that would normally be handled by a CPU. The DPU (110) in particular is useful for data compression tasks. The DPU (110) also includes functionality to perform all or some of the methods shown in FIGS. 2.1, 2.3, and 2.4. While one DPU (110) is shown in FIG. 1, multiple DPUs being used in the computing system (100) is contemplated. The DPU (110) can implement additional functionality without departing from the disclosure.

In one or more embodiments, the DPU (110) includes a specialized integrated circuit (not shown), a physical interface (not shown), packet processing components (not shown), accelerators (e.g., software and/or hardware based) (not shown) and DPU ports which are described below.

In one or more embodiments, DPU (110) includes multiple DPU ports (111A, 111N). The DPU may include any number of DPU ports (e.g., DPU port A (111A) through DPU port N (111N)). Each task assigned to the DPU (110) is mapped to one or more DPU ports (111A, 111N) on the DPU (110). This mapping allows the host adapter (120) of the computing system (100) to interact with the DPU and provides access to one or more components of the DPU (110). The DPU (110) is connected to the host adapter (120) to receive data and input/output (I/O) requests from inside the computing system (100) and outside the computing system (100). The DPU (110) is connected to the backend adapter (130) to transmit data processed by the DPU (110) to be stored in the storage (140). The DPU (110) is connected to the MVTS system (150) to provide data on the DPU ports (111A, 111N) to the MVTS system (150) to form activation schedules. The DPU (110) is connected to the DPU controller (160) to allow the DPU controller (160) to activate and deactivate the DPU ports (111A, 111N) on the DPU (110).

In one or more embodiments, the host adapter (120) is a communication bridge between inputs from other systems and the computing system (100). The host adapter includes functionality to receive data and requests from outside sources to be stored in the storage (140). The host adapter (120) may be connected to multiple host devices (not shown) to receive I/O requests and data. The connection between the host adapter (120) and the host devices may be one of the operative connections discussed above. The host adapter (120) transmits the data and the requests to the DPU (110) for processing prior to being stored. The host adapter (120) is connected to the MVTS system (150) to provide statistical data on the requests to allow the MVTS to forecast the usage of the DPU ports (111A, 111N). The host adapter (120) can implement additional functionality without departing from the disclosure.

In one or more embodiments, the backend adapter (130) is a bridge between the front-end (host adapter (120) and the DPU (110)) and the back-end (storage (140)). The backend adapter (130) includes functionality to transmit data and messages between the DPU (110) and the storage (140). The backend adapter (130) can implement additional functionality without departing from the disclosure.

In one or more embodiments, the storage (140) may utilize, to store data, volatile storage, non-volatile storage, or any combination thereof to store the aforementioned data. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), and persistent memory (PMEM).

In one or more embodiments, the storage (140) may be implemented as a file store. When implemented as a file store, the storage (140) stores data as files and manages the files using a file system. The file system may organize the files within a hierarchy using, for example, directories and/or folders. In another embodiment, the storage (140) may be implemented as an object store. When implemented as an object store, the data is stored as discrete units called objects (instead of files). Each object includes the data itself, metadata that describes the data, and a unique identifier, allowing for efficient retrieval and organization. The storage (140) includes functionality to store data received from the backend adapter (130). The storage (140) can implement additional functionality without departing from the disclosure.

In one or more embodiments, the MVTS system (150) includes functionality to create activation schedules for the DPU ports (111A, 111N). The MVTS system may create the activation schedules using an MTSM model. The MTSM model is a machine learning model that uses information on the data processed by the DPU (110) and information on the DPU ports as inputs to generate, as an output, an activation schedule which gives time periods when each DPU port (111A, 111N) should be activated or deactivated. MTSM models are models that track multiple variables (data to be processed, amount of active DPU ports) across time.

In one or more embodiments, the MTSM model includes an autoregressive integrated moving average (ARIMA) model. The ARIMA model is a statistical model that uses time series analysis to forecast future values of a data set based on a combination of past values, a difference between past values, and errors in previous predictions. In one or more embodiments, the MTSM model includes a deep learning long short-term memory (LSTM) model. The deep learning LSTM model is an artificial neural network adept at learning and remembering long-term dependencies in sequential data. Therefore, the deep learning LSTM model may track long standing patterns in the I/O requests when generating the activation schedules.

In one or more embodiments, the DPU controller (160) includes functionality to activate and deactivate DPU ports (111A, 111N) in the DPU (110). The DPU controller (160) is connected to the DPU ports (111A, 111N). The connection between DPU controller (160) and the DPU ports (111A, 111N) may be one of the operative connections discussed above. The storage (140) can implement additional functionality without departing from the disclosure.

Turning now to FIG. 2.1, FIG. 2.1 shows a flowchart for a method for creating an activation schedule in accordance one or more embodiments disclosed herein. The method of FIG. 2.1 may be performed by, for example, the MVTS system (e.g., 150, FIG. 1). Other components of the system of FIG. 1 may perform all, or a portion, of the method of FIG. 2.1 without departing from the disclosure.

While the various steps in the flowcharts of FIGS. 2.1, 2.3, and 2.4 are presented and described sequentially, one of ordinary skill in the relevant art will appreciate that some or all of the steps may be executed in different orders, may be combined, or omitted, and some or all steps may be executed in parallel.

In Step 200, the MVTS system receives data on I/O statistics from a host adapter (e.g., 120, FIG. 1). The data on I/O statistics includes a write I/O count, a size of data on the host adapter, compressibility of the data, and a data reduction ratio of the data. This data generally relates to the total amount of DPU resources that are consumed in the computing system.

In Step 202, the MVTS system receives data from DPU ports (e.g., 111A, FIG. 1). The data for the DPU ports includes a number of DPU ports in a computing system (e.g., 100, FIG. 1), a current status of each DPU port in the computing system (e.g., ON/OFF), resources related to each port (e.g., networking resources, computing resources, etc.), and a current power consumption of each DPU port.

In Step 204, the MVTS system forms an activation schedule from the DPU ports with the data on I/O statistics and the data on the DPU ports as inputs. The MVTS system uses an MTSM including a machine learning model to classify and forecast the usage of the DPU ports to form the activation schedule. The machine learning model may be an ARIMA model including machine learning elements or a deep learning LSTM model to do the forecasting. The data on I/O statistics and the data for the DPU ports are used as inputs into the MTSM. The activation schedule specifies whether any given DPU port is activated or deactivated over a series of time periods. The activation schedule is discussed further in FIG. 2.2.

In Step 206, the MVTS system provides the activation schedule to a DPU controller (e.g., 160, FIG. 1). The DPU controller activates (turns on) and deactivates (turns off) DPU ports according to the activation schedule. In one or more embodiments, the choice of which DPU ports to activate or deactivate is based on total activation time of each port which may enable the system to maintain about the same amount of activation time across the DPU ports. Further, in one or more embodiments, the choice of which DPU ports to activate or deactivate is based on default settings, such as deactivating the ports in a set order until the scheduled number of ports have been deactivated.

For example, the activation schedule specifies that, in a first time period, a first DPU port should be kept in an activated state and a second DPU port, a third DPU port, and a fourth DPU port should be kept in a deactivated state. At the time of receiving the activation schedule, the first DPU port and the second DPU port are activated and the third DPU port and the fourth DPU port are deactivated. When the first time period begins, the DPU controller will deactivate the second DPU port as indicated by the activation schedule while leaving the rest of the DPU ports in their current state (i.e., the first DPU port is left activated and the third DPU port and the fourth DPU port are left deactivated). The activation schedule specifies that, in a second time period, the first DPU port, the second DPU port, and the third DPU port should be kept in an activated state and the fourth DPU port should be kept in a deactivated state. When the second time period begins, the DPU controller will activate the second DPU port and the third DPU port as indicated by the activation schedule. The deactivated DPU ports either consume a nominal amount of power or do not consume any power, leading to energy conservation by having DPU ports non-active.

After Step 206, the method may be repeated by returning to Step 200 for the MVTS system to receive new data on I/O statistics. The new data is used to create a new activation schedule for time periods after the conclusion of the time periods of the activation schedule. Collecting new data allows for the forecasts to be more accurate. As such, the method in FIG. 2.1 can be seen as a recursive method to continually monitor and improve the activation schedules for DPU ports.

Turning to FIG. 2.2, FIG. 2.2 shows an example activation schedule in accordance one or more embodiments disclosed herein. The activation schedule shows a system that contains four DPU ports and shows a configuration of the four DPU ports over four time periods. In a first time period one DPU port is active, in a second time period three DPU ports are activate. In a third time period, two DPU ports are active. In a fourth time period, four DPU ports are active. The number of DPU ports is dependent on the activation schedule that is created to manage the DPU. Further, it should be appreciated that the amount of time periods may include any number of time periods and the length of the time periods may include any length of time. The MVTS system can be configured to allow for adjustment of the amount and length of time periods to be changed. For example, if the system is changing tasks more rapidly than reflected in the activation schedule, the length of the time periods may be shortened. In one or more embodiments, the length of time may have a minimum value of analysis, which may be set by a user or limited by the time delay between activating and deactivating a port. For example, a longer minimum length of time may consume less resources to create predictions for, thereby enabling quicker scheduling by the MVTS.

Turning now to FIG. 2.3, FIG. 2.3 shows a flowchart for a method for creating input/output statistics in accordance one or more embodiments disclosed herein. The method of FIG. 2.3 may be performed by, for example, the host adapter (e.g., 120, FIG. 1). Other components of the system of FIG. 1 may perform all, or a portion, of the method of FIG. 2.3 without departing from the disclosure.

In Step 210, the host adapter receives I/O requests from a data source. The I/O requests may be requests to write user data from a separate system to a storage (e.g., 140, FIG. 1) in a storage array where the host adapter is a component of the storage array. The host adapter receives the data to be stored in the storage and may transport the data to the DPU to be compressed.

In Step 212, the host adapter generates I/O statistics based on the received I/O data. The I/O statistics includes a write I/O count of data received at the host adapter, a size of the user data on the host adapter, the compressibility of the user data, and a data reduction ratio of the user data. The host adapter may analyze the metadata of the user data with built-in processors to obtain these I/O statistics.

In Step 214, the host adapter provides I/O statistics to a MVTS system (e.g., 150, FIG. 1). The host adapter is connected to the MVTS system and transmits these I/O statistics to the MVTS system. The MVTS system uses the I/O statistics to form activation schedules for DPU ports. The MVTS system use the I/O statistics to determine how many DPU ports would be needed to perform the tasks assigned to the DPU(s).

After Step 214, the method may end.

FIG. 2.4 shows a flowchart for a method for compressing data in accordance one or more embodiments disclosed herein.

Turning now to FIG. 2.4, FIG. 2.4 shows a flowchart for a method for compressing data in accordance one or more embodiments disclosed herein. The method of FIG. 2.4 may be performed by, for example, the DPU (e.g., 110, FIG. 1). Other components of the system of FIG. 1 may perform all, or a portion, of the method of FIG. 2.4 without departing from the disclosure.

In Step 220, the DPU receives I/O requests from a host adapter (e.g., 120, FIG. 1). In one or more embodiments, the I/O requests might be the I/O requests from FIG. 2.3. The I/O requests may include data that is to be compressed by the DPU.

In Step 222, the DPU processes the I/O requests using active DPU ports (e.g., 111A, FIG. 1) on the DPU to obtain compressed data. The data may be compressed by active DPU ports. For example, the DPU may contain four DPU ports. The first two DPU ports are active and the other two DPU ports are inactive. The DPU will split the data compression of the I/O requests between the first two DPU ports. The first two DPU ports will generate compressed data to be stored in the storage.

In Step 224, the DPU stores the compressed data in a storage (e.g., 140, FIG. 1) via a backend adapter (e.g., 130, FIG. 1). The DPU will transmit the compressed data to the backend adapter. The backend adapter will communicate with the storage to find a location on the storage to store the compressed data. The backend adapter will then store the data in the location of the storage. In one or more embodiments, not all data from the I/O request will be compressed. The DPU will transmit the uncompressed data to be stored in the storage with the compressed data.

After Step 224, the method may end.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for managing data processing units (DPU) ports in a DPU, comprising:
receiving, at a multi-variant time series (MVTS) system, first data on input/output (I/O) statistics on a host adapter;
receiving, at the MVTS system, second data from the DPU, wherein:
the second data comprises a status and power consumption of each DPU port of the DPU, and
the DPU comprises a first DPU port and a second DPU port that have a first status of activated and a third DPU port and a fourth DPU port that have a second status of deactivated;
after receiving the first data and the second data, forming, with the MVTS system, an activation schedule for each DPU port in the DPU with the first data and the second data as inputs, wherein the activation schedule specifies whether any given DPU port is activated or deactivated over a series of time periods; and
deactivating, at a first time period, the second DPU port, wherein the activation schedule specifies that during the first time period the first DPU port is activated and the second DPU port, the third DPU port, and the fourth DPU port are deactivated.

2. The method of claim 1, further comprising:
performing, during the first time period, data compression on first user data from the host adapter using the first DPU port; and
after compressing the first user data, storing compressed first user data in storage, wherein the storage is on a computing system in which the DPU is located.

3. The method of claim 1, further comprising:
activating, at a second time period, the second DPU port and the third DPU port based on the activation schedule.

4. The method of claim 3, further comprising:
performing, during the second time period, data compression on second user data from the host adapter using the first DPU port, the second DPU port, and the third DPU port; and
after compressing the second user data, storing compressed second user data in a storage.

5. The method of claim 1, wherein the first data on write input/output statistics comprise a write I/O count, a size of user data on the host adapter, compressibility of the user data, and a data reduction ratio of the user data.

6. The method of claim 1, wherein the MVTS system comprises an autoregressive integrated moving average model or a deep learning long short-term memory model.

7. The method of claim 1, wherein after deactivating the second DPU port, the second DPU port, the third DPU port, and the fourth DPU port do not consume power.

8. A non-transitory computer readable medium (CRM) comprising computer readable program code, which when executed by a computer processor enables the computer processor to perform a method for managing data processing units (DPU) ports in a DPU, the method, comprising:
receiving, at a multi-variant time series (MVTS) system, first data on input/output (I/O) statistics on a host adapter;
receiving, at the MVTS system, second data from the DPU, wherein:
the second data comprises a status and power consumption of each DPU port of the DPU, and
the DPU comprises a first DPU port and a second DPU port that have a first status of activated and a third DPU port and a fourth DPU port that have a second status of deactivated;
after receiving the first data and the second data, forming, with the MVTS system, an activation schedule for each DPU port in the DPU with the first data and the second data as inputs, wherein the activation schedule specifies whether any given DPU port is activated or deactivated over a series of time periods; and
deactivating, at a first time period, the second DPU port, wherein the activation schedule specifies that during the first time period the first DPU port is activated and the second DPU port, the third DPU port, and the fourth DPU port are deactivated.

9. The non-transitory CRM of claim 8, further comprising:
performing, during the first time period, data compression on first user data from the host adapter using the first DPU port; and
after compressing the first user data, storing compressed first user data in storage, wherein the storage is on a computing system in which the DPU is located.

10. The non-transitory CRM of claim 8, further comprising:
activating, at a second time period, the second DPU port and the third DPU port based on the activation schedule.

11. The non-transitory CRM of claim 10, further comprising:
performing, during the second time period, data compression on second user data from the host adapter using the first DPU port, the second DPU port, and the third DPU port; and
after compressing the second user data, storing compressed second user data in a storage.

12. The non-transitory CRM of claim 8, wherein the first data on write input/output statistics comprise a write I/O count, a size of user data on the host adapter, compressibility of the user data, and a data reduction ratio of the user data.

13. The non-transitory CRM of claim 8, wherein the MVTS system comprises an autoregressive integrated moving average model or a deep learning long short-term memory model.

14. The non-transitory CRM of claim 8, wherein after deactivating the second DPU port, the second DPU port, the third DPU port, and the fourth DPU port do not consume power.

15. A computing system, comprising:
a processor;
a data processing unit (DPU);
a storage comprising instructions, which when executed by the processor perform a method, the method comprising:
receiving, at a multi-variant time series (MVTS) system, first data on input/output (I/O) statistics on a host adapter;
receiving, at the MVTS system, second data from the DPU, wherein:
the second data comprises a status and power consumption of each DPU port of the DPU, and
the DPU comprises a first DPU port and a second DPU port that have a first status of activated and a third DPU port and a fourth DPU port that have a second status of deactivated;
after receiving the first data and the second data, forming, with the MVTS system, an activation schedule for each DPU port in the DPU with the first data and the second data as inputs, wherein the activation schedule specifies whether any given DPU port is activated or deactivated over a series of time periods; and
deactivating, at a first time period, the second DPU port, wherein the activation schedule specifies that during the first time period the first DPU port is activated and the second DPU port, the third DPU port, and the fourth DPU port are deactivated.

16. The computing system of claim 15, wherein the method further comprises:
performing, during the first time period, data compression on first user data from the host adapter using the first DPU port; and
after compressing the first user data, storing compressed first user data in the storage, wherein the storage is on a computing system in which the DPU is located.

17. The computing system of claim 15, wherein the method further comprises:
activating, at a second time period, the second DPU port and the third DPU port based on the activation schedule.

18. The computing system of claim 17, wherein the method further comprises:
performing, during the second time period, data compression on second user data from the host adapter using the first DPU port, the second DPU port, and the third DPU port; and
after compressing the second user data, storing compressed second user data in the storage.

19. The computing system of claim 15, wherein the first data on write input/output statistics comprise a write I/O count, a size of user data on the host adapter, compressibility of the user data, and a data reduction ratio of the user data.

20. The computing system of claim 15, wherein after deactivating the second DPU port, the second DPU port, the third DPU port, and the fourth DPU port do not consume power.
